(19) United States
(12) Patent Application Publication
(10) Pub. No.: US 2026/0289534 A1
(43) Pub. Date: Sep. 24, 2026

(54) ONLINE SUBSCRIPTION SYSTEM AND METHOD, STORAGE MEDIUM, AND COMPUTER SYSTEM

(71) Applicant: Advanced Nova Technologies (Singapore) Holding Pte, Ltd., Singapore (SG)

(72) Inventors: Haohao LIU, Hangzhou (CN); Dekai CHEN, Hangzhou (CN); Wanglin TONG, Hangzhou (CN)

(73) Assignee: Advanced Nova Technologies (Singapore) Holding Pte, Ltd., Singapore (SG)

(21) Appl. No.: 19/436,864

(22) Filed: Dec. 30, 2025

(30) Foreign Application Priority Data
Mar. 19, 2025 (SG) 10202500713T

(51) Int. Cl. G06Q 20/10; G06Q 20/40; G06Q 50/10

(52) U.S. Cl. CPC G06Q 20/102; G06Q 20/401; G06Q 50/10

(57) ABSTRACT

Computer-implemented systems, methods, storage media for online subscription are disclosed. An example system includes a merchant platform, a payment institution, and a payment service provider (PSP), and the payment institution includes a client and a server. The merchant platform sends a user’s subscription request to the server using the PSP in response to the subscription request. The server determines a subscription address based on the subscription request, and sends the subscription address to the merchant platform using the PSP. The merchant platform enables, based on the subscription address, the user to execute a subscription service using the client. When the client does not return a subscription result, the PSP generates a query instruction based on a subscription identifier, and sends the query instruction to the server. The server queries the subscription result based on the query instruction, and returns the subscription result to the merchant platform using the PSP.

### CROSS-REFERENCE TO RELATED APPLICATIONS

This application claims priority to Singapore Patent Application No. 10202500713T, filed on Mar. 19, 2025, which is hereby incorporated by reference in its entirety.

### TECHNICAL FIELD

This specification relates to the field of computer technologies, and in particular, to an online subscription system and method, a storage medium, and a computer system.

### BACKGROUND

With development of information technology, an online payment is applied more widely. In addition, more merchants provide online payment services to users by using payment service providers. The payment service provider (PSP for short) is an institution that provides a payment service to a merchant, and the payment service can be a deduction payment.

At present, during the deduction payment, usually, subscription is performed, and after subscription is completed, the payment is completed through deduction by the merchant. When subscription is performed, FIG. 1 is a schematic diagram of a subscription process according to this specification. The subscription process shown in FIG. 1 includes a merchant, a user, a payment service provider, and a client and a server of a payment institution. First, the merchant responds to a subscription request of the user, and then sends the subscription request to the payment service provider, so that the payment service provider sends the subscription request to the server of the payment institution. The server determines a subscription address, and returns the subscription address to the payment service provider, and the payment service provider sends the subscription address to the merchant, so that the merchant jumps to a subscription page corresponding to the subscription address, and the subscription page is displayed by the client of the payment institution to the user. Then, the user performs a subscription operation on the subscription page. The server determines a subscription result based on interaction between the user and the subscription page, and returns the subscription result to the payment service provider by using the client. The payment service provider sends the subscription result to the merchant, so that the merchant determines a subscription result page based on the subscription result, and displays the and a server to the user.

In addition, for example, in the process shown in FIG. 1, the subscription result is an authorization code. Specifically, when the subscription result is an authorization code, the merchant can invoke an interface to send the authorization code to the payment service provider, and then the payment service provider sends the authorization code to the server, so that the server determines a token based on the authorization code, and returns the token to the payment service provider. The payment service provider returns the token to the merchant, so that the merchant displays a subscription success page to the user after receiving the token. Then, during a payment, the merchant can request a deduction from the server of the payment institution of the user by using the token as a voucher.

However, the client of the payment institution cannot return the authorization code to the payment service provider because network quality of a region in which the user is located is poor, the user performs a misoperation, or a user terminal is faulty. Consequently, the merchant cannot obtain the authorization code, and cannot obtain the token. Consequently, a subscription fails, and a deduction payment cannot be used in a subsequent payment, thereby reducing a total transaction amount of the merchant. Therefore, how to perform online subscription is a very important problem.

In view of this, this specification provides an online subscription system.

### SUMMARY

This specification provides an online subscription system and method, a storage medium, and a computer system, to partially resolve the above-mentioned problems in the conventional technology.

This specification provides an online subscription system. The system includes a merchant platform, a payment institution, and a payment service provider, and the payment institution includes a client and a server. The merchant platform is configured to send a subscription request of a user to the server by using the payment service provider in response to the subscription request. The subscription request includes at least a subscription identifier, and the subscription identifier is used to uniquely identify a subscription service corresponding to the subscription request. The server is configured to: determine a subscription address based on the received subscription request, and send the subscription address to the merchant platform by using the payment service provider. The merchant platform is configured to enable, based on the subscription address, the user to execute the subscription service by using the client. The payment service provider is configured to: generate, based on the subscription identifier when the client does not return a subscription result, a query instruction used to query a subscription result of the subscription service, and send the query instruction to the server. The server is configured to: query the subscription result based on the received query instruction, and return the subscription result to the merchant platform by using the payment service provider.

This specification provides an online subscription method. The method is applied to a payment service provider, and the method includes: receiving a subscription request, and sending the subscription request to a server of a payment institution, so that the server determines a subscription address based on the subscription request, and returns the subscription address, where the subscription request is sent by a merchant platform to the payment service provider, the subscription request includes at least a subscription identifier, and the subscription identifier is used to uniquely identify a subscription service corresponding to the subscription request; sending, to the merchant platform, the subscription address returned by the server, so that the merchant platform enables, based on the subscription address, a user to execute the subscription service by using a client of the payment institution; generating, based on the subscription identifier when the client does not return a subscription result, a query instruction used to query a subscription result of the subscription service, and sending the query instruction to the server, so that the server queries the subscription result based on the received query instruction, and returns the subscription result to the payment service provider; and sending, to the merchant platform, the subscription result returned by the server.

This specification provides a computer system for online subscription, including a storage, a processor, and a computer program that is stored in the storage and that is capable of running on the processor. When the processor executes the program, the following steps are implemented: receiving a subscription request, and sending the subscription request to a server of a payment institution, so that the server determines a subscription address based on the subscription request, and returns the subscription address, where the subscription request is sent by a merchant platform to the payment service provider, the subscription request includes at least a subscription identifier, and the subscription identifier is used to uniquely identify a subscription service corresponding to the subscription request; sending, to the merchant platform, the subscription address returned by the server, so that the merchant platform enables, based on the subscription address, a user to execute the subscription service by using a client of the payment institution; generating, based on the subscription identifier when the client does not return a subscription result, a query instruction used to query a subscription result of the subscription service, and sending the query instruction to the server, so that the server queries the subscription result based on the received query instruction, and returns the subscription result to the payment service provider; and sending, to the merchant platform, the subscription result returned by the server.

This specification provides a computer-readable storage medium. The storage medium stores a computer program, and when the computer program is executed by a processor, the online subscription method is implemented.

The above-mentioned at least one technical solution used in this specification can achieve the following beneficial effects:

The above-mentioned at least one technical solution used in the embodiments of this specification can achieve at least one of the following beneficial effects: When subscription is performed, when a client of a payment institution does not return a subscription result to a payment service provider, the payment service provider can actively send a query instruction to a server of the payment institution, so that the server queries a subscription result based on thee query instruction, and returns the query instruction to the payment service provider. This avoids a problem that the client cannot return the subscription result to the payment service provider because network quality of a region in which a user is located is poor, a user performs a misoperation, or a user terminal is faulty, thereby avoiding a case in which a merchant waits for a long period of time, improving a subscription speed of the user, and bringing better user experience, thereby improving a total transaction amount of the merchant.

### BRIEF DESCRIPTION OF DRAWINGS

The accompanying drawings described herein are used to provide a further understanding of this specification and constitute a part of this specification. The example embodiments of this specification and descriptions thereof are used to explain this specification, and do not constitute an improper limitation on this specification. In the accompanying drawings:

FIG. 1 is a schematic diagram of a subscription process according to this specification;

FIG. 2 is a schematic diagram of an online subscription process according to this specification;

FIG. 3 is a schematic diagram of an online subscription system according to this specification;

FIG. 4 is a schematic diagram of a subscription page according to this specification;

FIG. 5 is a schematic diagram of a subscription failure page according to this specification;

FIG. 6 is a schematic diagram of a subscription success page according to this specification;

FIG. 7 is a schematic diagram of a token determining process according to this specification;

FIG. 8 is a schematic diagram of a verification page for entering a payment password according to this specification;

FIG. 9 is a schematic diagram of a payment process according to this specification;

FIG. 10 is a schematic flowchart of an online subscription method according to this specification;

FIG. 11 is a schematic flowchart of another online subscription method according to this specification; and

FIG. 12 is a schematic structural diagram of a computer system corresponding to FIG. 10 according to this specification.

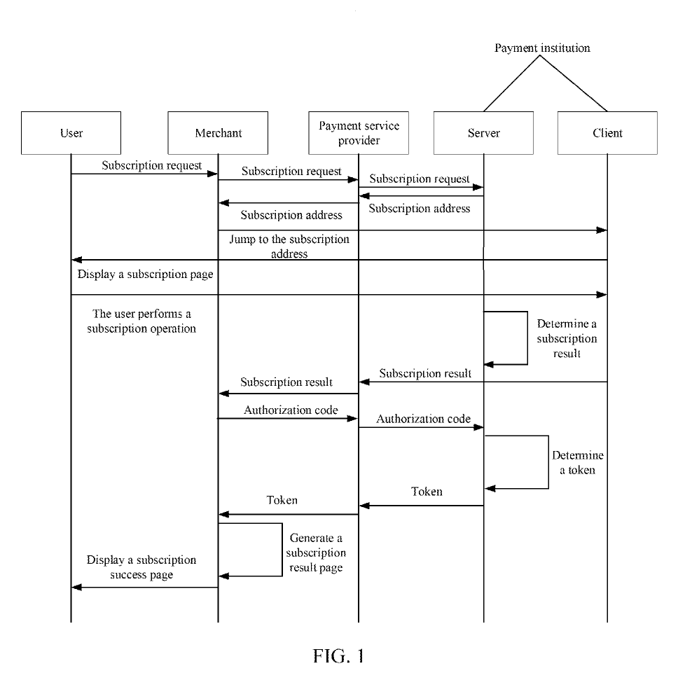

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of embodiments of this specification. All other embodiments obtained by a person of ordinary skill in the art based on the embodiment of this specification without creative efforts shall fall within the protection scope of this specification.

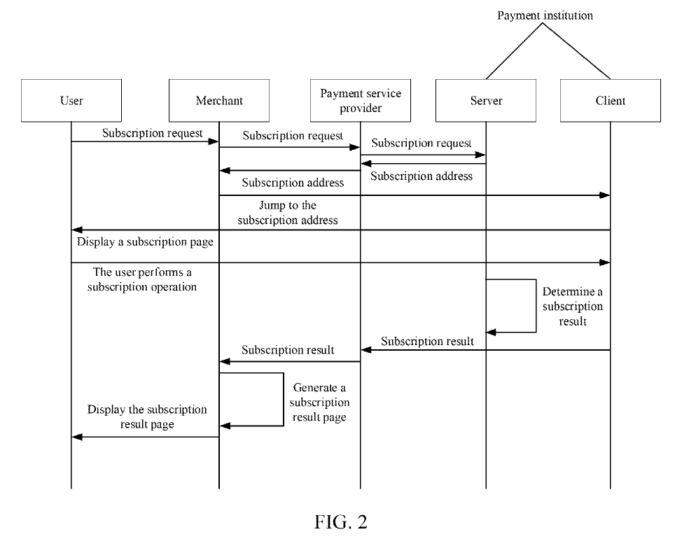

At present, when subscription of a deduction payment is performed, FIG. 2 is a schematic diagram of an online subscription process according to this specification. The subscription process shown in FIG. 2 includes a merchant platform, a user, a payment service provider, and a client and a server of a payment institution. First, the merchant platform responds to a subscription request of the user, and then sends the subscription request to the payment service provider, so that the payment service provider sends the subscription request to the server of the payment institution. The server determines a subscription address, and returns the subscription address to the payment service provider, and the payment service provider sends the subscription address to the merchant platform, so that the merchant platform jumps to a subscription page corresponding to the subscription address, and the subscription page is displayed by the client of the payment institution to the user. Then, the user performs a subscription operation on the subscription page. The server determines a subscription result based on interaction between the user and the subscription page, and returns the subscription result to the payment service provider by using the client. The payment service provider sends the subscription result to the merchant platform, so that the merchant platform determines a subscription result page based on the subscription result, and displays the and a server to the user.

However, because network quality of a region in which the user is located is poor, a user performs a misoperation (that is, the user accidentally closes the client), or the user terminal is faulty, the client cannot return the subscription result to the payment service provider, and consequently, the merchant platform waits for a long period of time.

In view of this, the embodiments of this specification provide an online subscription system and method, a storage medium, and a computer system. The following describes in detail the technical solutions provided in the embodiments of this specification with reference to the accompanying drawings.

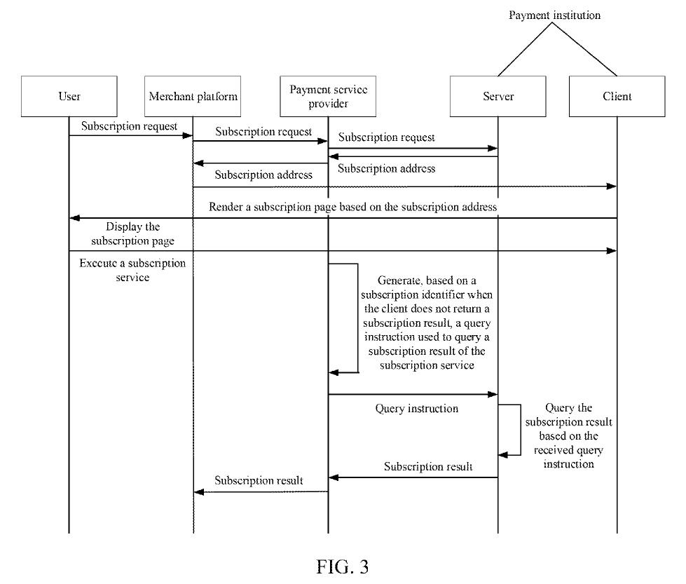

FIG. 3 is a schematic diagram of an online subscription system according to this specification. The system shown in FIG. 3 includes a merchant platform, a payment institution, and a payment service provider. The payment institution includes a client and a server.

First, the merchant platform can be configured to send a subscription request of a user to the server by using the payment service provider in response to the subscription request. The merchant platform can be any existing platform that can perform a transaction with the user, for example, a shopping platform or a retail platform. A specific merchant platform is not specifically limited in this specification. The payment service provider (PSP for short) is an institution that provides a payment service to a merchant (namely, merchant platform), and the payment service can be a deduction payment. The payment service provider includes a plurality of payment institutions, and is responsible for encapsulating a complex underlying data path, and provides a simplified entry for the merchant platform, so that the merchant platform supports the plurality of payment institutions to perform a payment. That is, the merchant platform can interact only with the payment service provider, and does not need to directly interact with the plurality of payment institutions, and the payment service provider interacts with the plurality of payment institutions. The payment service provider is any existing institution that provides the payment service for the merchant platform, which is not specifically limited in this specification. The payment institution is a payment institution included by the payment service provider, and the payment institution can be a third-party platform, a bank, etc. that provides the payment service, which is not specifically limited in this specification.

The subscription request includes at least a subscription identifier, and the subscription identifier is used to uniquely identify a subscription service corresponding to the subscription request. Each subscription request corresponds to one subscription service, and each subscription service has a unique subscription identifier. The subscription identifier can be a number, a letter, or a character, which is not specifically limited in this specification. In addition, in addition to the subscription identifier, the subscription request can further include an institution identifier. The institution identifier is a unique identifier of the payment institution, and each payment institution has a corresponding unique institution identifier. The institution identifier can be a number, a letter, or a character. Certainly, the institution identifier can alternatively be a name of the payment institution, which is not specifically limited in this specification.

Specifically, the merchant platform can send the subscription request of the user to the payment service provider in response to the subscription request, and the payment service provider sends the subscription request to the server of the payment institution. The subscription request can include the institution identifier, and the payment service provider can access a plurality of payment institutions. Therefore, when sending the subscription request to the server of the payment institution, the payment service provider can determine the payment institution corresponding to the institution identifier based on the institution identifier in the subscription request, and send the subscription request to the server of the payment institution corresponding to the institution identifier. The institution identifier can be an identifier of a payment institution selected by the user. Specifically, the merchant platform can display all to-be-selected payment institutions to the user, and the user can select a required payment institution from all the to-be-selected payment institutions, so that the subscription request includes the institution identifier of the payment institution selected by the user. All the to-be-selected payment institutions are payment institutions included by the payment service provider. Certainly, if the payment service provider includes only one payment institution, the user does not need to perform selection, and the subscription request does not need to include the institution identifier. After receiving the subscription request, the payment service provider directly sends the subscription request to the server of the payment institution.

Then, the server can be configured to: determine a subscription address based on the received subscription request, and send the subscription address to the merchant platform by using the payment service provider. The subscription address can be generated by the server based on the subscription request, and the subscription address is an address corresponding to a subscription page. The subscription request can further include a platform identifier. The platform identifier is a unique identifier of the merchant platform. The platform identifier can be a number, a letter, or a character. Certainly, the platform identifier can alternatively be a name of the merchant platform, which is not specifically limited in this specification. Specifically, the server can determine the subscription address based on the received subscription request, and return the subscription address to the payment service provider. The payment service provider returns, to the merchant platform, the subscription address returned by the server.

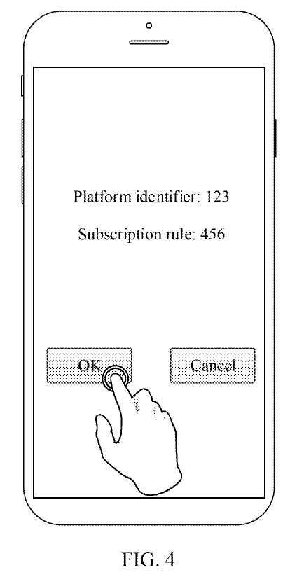

Then, the merchant platform can be configured to enable, based on the subscription address, the user to execute the subscription service by using the client. The subscription service is that the user performs a subscription operation or cancellation operation on a subscription page displayed on the client. Specifically, the merchant platform can render the subscription page based on the subscription address, and display the subscription page to the user by using the client. That is, the merchant platform can jump to the subscription address, and display the subscription page to the user by using the client. The subscription page can include a platform identifier, a subscription rule, a first button, and a second button, the first button represents that the user confirms subscription, the second button represents that the user cancels subscription, and the subscription rule is preset by the server, and specific content is not specifically limited in this specification. When the user taps the first button, it indicates that the user performs the subscription operation, and indicates that the user performs subscription. When the user taps the second button, it indicates that the user performs the cancellation operation, and indicates that the user cancels subscription. Specifically, FIG. 4 is a schematic diagram of a subscription page according to this specification. A button marked with "Confirm" is the first button, and a button marked with "Cancel" is the second button. For example, the platform identifier on the subscription page shown in FIG. 4 is "123", and the subscription rule is "456". It should be noted that FIG. 4 shows only an example of the subscription page. A specific platform identifier on the subscription page can be determined based on the subscription request, and specific content of the subscription rule can be preset by the server. For example, on the subscription page shown in FIG. 4, the user taps the button marked with "Confirm".

After the subscription page is displayed to the user by using the client, the user can read content displayed on the subscription page. When subscription is confirmed, the user can tap the first button, so that the client can determine, in response to a first tap operation of the user, that the user performs subscription. The client can send, to the server, a message indicating that the user performs subscription, so that the server generates an authorization code when the user performs subscription, and sends the authorization code to the client, so that the client returns the authorization code to the payment service provider. In addition, when subscription is canceled, the user can tap the second button, so that the client can determine, in response to a second tap operation of the user, that the user cancels subscription. The client can send, to the server, a message indicating that the user cancels subscription, so that the server generates failure information when the user cancels the subscription, and sends the failure information to the client, so that the client returns the failure information to the payment service provider. The first tap operation represents that the user performs subscription, and the second tap operation represents that the user cancels subscription. The authorization code and the failure information are generated by the server, and are returned by the client to the payment service provider. The authorization code or the failure information is a subscription result corresponding to the subscription service. The authorization code is an identifier representing that the user performs subscription, the failure information represents that the user cancels subscription, and the failure information can be "subscription is canceled".

However, when network quality of a region in which the user is located is poor, the user performs a misoperation (that is, the user accidentally closes the client), or a user terminal is faulty, the client cannot return the subscription result (namely, the authorization code or the failure information) to the payment service provider. Therefore, the payment service provider can be configured to: when the client does not return the subscription result, generate, based on the subscription identifier, a query instruction used to query a subscription result of the subscription service, and send the query instruction to the server. The query instruction is used to query the subscription result of a subscription service, and the query instruction carries the subscription identifier.

Then, the server can be configured to: query the subscription result based on the received query instruction, and return the subscription result to the merchant platform by using the payment service provider. The subscription result includes one of the authorization code and the failure information. Specifically, the server can query the subscription result based on the received query instruction, and send the subscription result to the payment service provider. The payment service provider returns the subscription result to the merchant platform. When querying the subscription result based on the received query instruction, the server can query the subscription result corresponding to the subscription identifier based on the subscription identifier in the received query instruction.

Based on the online subscription system shown in FIG. 3, when online subscription is performed, the merchant platform can send the subscription request to the server by using the payment service provider in response to the subscription request of the user. The server can determine the subscription address based on the received subscription request, and send the subscription address to the merchant platform by using the payment service provider. The merchant platform can enable, based on the subscription address, the user to execute the subscription service by using the client. When the client does not return the subscription result, the payment service provider can generate, based on the subscription identifier, the query instruction used to query the subscription result of the subscription service, and send the query instruction to the server. The server queries the subscription result based on the received query instruction, and returns the subscription result to the merchant platform by using the payment service provider. When the client does not return the subscription result, the payment service provider actively sends the query instruction to the server of the payment institution, so that the server queries the subscription result based on the query instruction, and returns the subscription result to the payment service provider. This avoids a problem that the client cannot return the subscription result to the payment service provider because the network quality of the region in which the user is located is poor, the user performs a misoperation, or the user terminal is faulty, to avoid a case in which the merchant platform waits for a long period of time, improve a subscription speed of the user, and improve a total transaction amount of the merchant.

In one or more embodiments of this specification, to accelerate the subscription speed, the payment service provider can directly generate the query instruction based on the subscription identifier before sending the subscription address to the merchant platform, or after receiving the subscription address returned by the server, and send the query instruction to the server, to accelerate the subscription speed, and avoid waiting for the subscription result for a long period of time. Therefore, before sending the subscription address to the merchant platform, or after receiving the subscription address returned by the server, and when the client does not return the subscription result, the payment service provider can generate, based on the subscription identifier, the query instruction used to query the subscription result of the subscription service, and send the query instruction to the server, so that the server queries the subscription result based on the query instruction, and returns the subscription result. In addition, in this case, when the client returns the subscription result, the payment service provider can directly return, to the merchant platform, the subscription result returned by the client.

However, when the server receives the query instruction, the user may be reading content displayed on the subscription page, and has not performed a tap operation, that is, the user has not completed execution of the subscription service. Consequently, the server cannot query the subscription result of the subscription service corresponding to the subscription identifier, and consequently, the server cannot return the subscription result to the payment service provider. In view of this, the payment service provider can send the query instruction based on a specified period. Specifically, before sending the subscription address to the merchant platform, or after receiving the subscription address returned by the server, and when the client does not return the subscription result, the payment service provider can generate, based on the subscription identifier, the query instruction used to query the subscription result of the subscription service; send the query instruction to the server based on the specified period; and until receiving the subscription result returned by the server, return the subscription result to the merchant platform. The specified period is a period preset by the payment service provider, and the specified period can be 5 minutes. Certainly, the specified period can alternatively be another time set by the payment service provider, which is not specifically limited in this specification. However, if the client returns the subscription result in this case, the payment service provider can directly return, to the merchant platform, the subscription result returned by the client.

In addition, to avoid a case in which the payment service provider performs a plurality of queries and computational power resources of the payment service provider are wasted, the payment service provider can set a query threshold. When a quantity of queries reaches the threshold, and the server does not return the subscription result, the payment service provider can no longer send the query instruction to the server. Specifically, the payment service provider can send the query instruction to the server based on the specified period, and until the quantity of queries reaches the preset threshold, and the server does not return the subscription result, the payment service provider confirms to stop sending the query instruction to the server. The quantity of queries is a quantity of times that the payment service provider sends the query instruction to the server, and the preset threshold is a maximum quantity of queries preset by the payment service provider. Each payment institution has a corresponding maximum quantity of queries, and the maximum quantity of queries can be preset by the payment service provider.

In one or more embodiments of this specification, to reduce a waste of resources of the payment service provider, the payment service provider can generate the query instruction after waiting for a period of time, and then send the query instruction to the server, to avoid a case in which the user does not perform a tap operation on the subscription page when the server receives the query instruction, that is, avoid a case in which the server cannot query the subscription result corresponding to the subscription identifier after receiving the query instruction, and avoid a problem that the client does not return the subscription result because the user does not perform the tap operation on the subscription page. Therefore, the payment service provider can determine a delay time corresponding to the payment institution, and when the client does not return the subscription result within the delay time, generate, based on the subscription result, the query instruction used to query the subscription result of the subscription service. The delay time can be preset by the payment service provider, and the delay time is usually greater than a time required for executing the subscription service by the user. Specific duration of the delay time can be preset by the payment service provider. Each payment institution has a corresponding delay time, and delay times corresponding to different payment institutions can be the same or different. In addition, when the client returns the subscription result within the delay time, the payment service provider directly returns, to the merchant platform, the subscription result returned by the client.

In addition, to avoid a problem that the server cannot query the subscription result of the subscription service corresponding to the subscription identifier because the user does not complete execution of the subscription service when the server receives the query instruction, the payment service provider can generate, based on the subscription result when the client does not return the subscription result within the delay time, the query instruction used to query the subscription result of the subscription service; send the query instruction to the server based on the specified period; and until receiving the subscription result returned by the server, return the subscription result to the merchant platform. Similarly, to avoid a plurality of queries and a waste of resources, the payment service provider can set a maximum quantity of queries. When the quantity of queries reaches the maximum quantity of queries, and the server does not return the subscription result, the payment service provider can no longer send the query instruction to the server. A specific process is described in the above-mentioned content, and details are not described herein again.

In one or more embodiments of this specification, before sending the subscription address to the merchant platform or after receiving the subscription address returned by the server, the payment service provider can determine the delay time corresponding to the payment institution, generate a delay message based on the delay time, and send the delay message to the payment service provider. That is, the payment service provider can generate the delay message, and send the delay message to the payment service provider. Then, the payment service provider can generate, based on the subscription identifier when the client does not return the subscription result before the delay message is received, the query instruction used to query the subscription result of the subscription service. The delay message can include the subscription identifier. The delay message is used to delay generating and sending the query instruction by the payment service provider. Usually, after the delay message is sent to the payment service provider, the delay message is received only after the delay time elapses. That is, a time from sending of the delay message to receiving of the delay message is a delay time. In addition, after the query instruction is generated, the payment service provider can send the query instruction to the server based on the specified period. In addition, the maximum quantity of queries can be limited. A specific process is described in the above-mentioned content, and details are not described herein again.

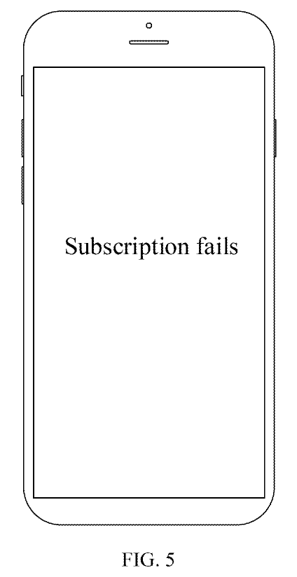

In one or more embodiments of this specification, to avoid a case in which the user or the merchant platform waits for a long period of time, thereby bringing poor experience to the user, the merchant platform can automatically generate a subscription failure page when the subscription result returned by the payment service provider is not received for a long period of time, and display the subscription failure page to the user. Specifically, when the subscription result returned by the payment service provider is not received within a specified time, the merchant platform can further determine that the subscription service fails, generate the subscription failure page, and display the subscription failure page to the user. The specified time is set on the merchant platform, and the specified time can be 10 minutes. Certainly, the specified time can alternatively be another time set on the merchant platform, which is not specifically limited in this specification. The subscription failure page can include a text representing a failure such as "Subscription fails" or "Subscription is unsuccessful". Specifically, FIG. 5 is a schematic diagram of a subscription failure page according to this specification. For example, the subscription failure page shown in FIG. 5 is "Subscription fails".

In one or more embodiments of this specification, when the payment service provider stops sending the query instruction to the server, to avoid a case in which the merchant platform waits for a long period of time, the payment service provider can generate a first message, and return the first message to the merchant platform, to notify the merchant platform that the payment service provider does not obtain the subscription result. The merchant platform can generate the subscription failure page based on the first message returned by the payment service provider, and display the subscription failure page to the user. The first message represents that the payment service provider does not obtain the subscription result.

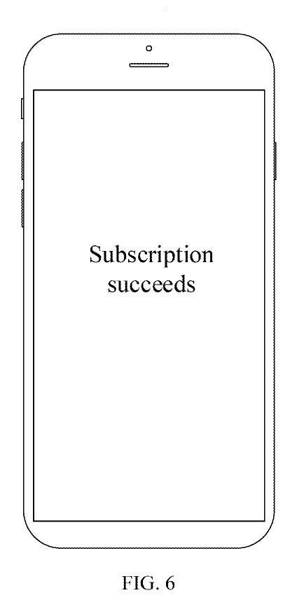

In one or more embodiments of this specification, when the subscription result is an authorization code, the merchant platform can further determine a token based on the authorization code by interacting with the payment service provider, and display a subscription success page to the user. However, when the subscription result is failure information, the subscription failure page is generated and displayed to the user. The token is a voucher for subsequently performing a deduction payment by the merchant platform. The token is generated by the server, the token can be an identifier represented by a number, a character, or a character, and there is a one-to-one correspondence between the authorization code and the token. The subscription success page can include a text representing a success such as "Subscription succeeds". Specifically, FIG. 6 is a schematic diagram of a subscription success page according to this specification. For example, the subscription success page shown in FIG. 6 is "Subscription succeeds".

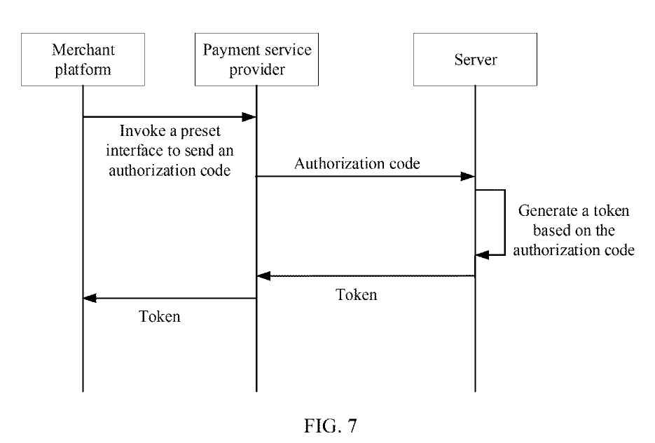

Specifically, when the subscription result is an authorization code, specifically, FIG. 7 is a schematic diagram of a process of determining a token according to this specification. The merchant platform can invoke a preset interface to send the authorization code to the payment service provider. The payment service provider can further send, to the server, the authorization code received based on the preset interface. The server can further determine the token based on the authorization code, and return the token to the payment service provider. The payment service provider can further send the token to the merchant platform. Then, the merchant platform can receive the token returned by the payment service provider. The preset interface is pre-agreed on by the merchant platform and the payment service provider, the preset interface can be an applyToken interface, and the preset interface is used to transmit the authorization code between the merchant platform and the payment service provider. The authorization code is further given to the merchant platform. Then, the merchant platform applies to the server for the token based on the authorization code, to avoid a case in which another device intercepts the authorization code, and further obtains the token, to ensure security of the token.

In addition, when determining the token based on the authorization code, the server can verify the authorization code, and determine the token based on the authorization code when the authorization code succeeds. When the authorization code is verified, the server can query the authorization code (namely, the authorization code sent by the payment service provider) from a generated historically authorization code. If the authorization code is found, it is determined that verification of the authorization code succeeds. If the authorization code is not found, it is determined that verification of the authorization code fails. Certainly, to better verify the authorization code, and provide accuracy of the authorization code, the payment service provider can send the authorization code and the platform identifier to the server together, so that the server can verify whether the authorization code and the platform identifier match each other, to verify correctness of the authorization code. Specifically, when the authorization code and the platform identifier match each other, it indicates that the authorization code is historically generated by the server, and is returned to the merchant platform, and it is determined that verification of the authorization code succeeds. When the authorization code and the platform identifier do not match each other, it indicates that the authorization code is not historically generated by the server and returned to the merchant platform, and it is determined that verification of the authorization code fails.

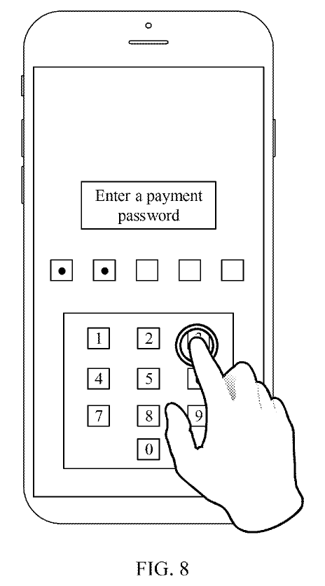

In one or more embodiments of this specification, when the client can determine, in response to the first tap operation of the user, that the user performs subscription, to ensure validity of user subscription, the client can verify an identity of the user. Specifically, the client can verify the identity of the user by verifying a payment password, through SMS verification, etc., and when user verification succeeds, the client sends, to the server, the message indicating that the user performs subscription. For example, the payment password is verified. When the identity of the user is verified, after determining that the user performs subscription, the client can generate a verification page and display the verification page to the user. The user can enter the payment password on the verification page. The verification page includes prompt information, several input boxes, and an input keyboard. The prompt information is prompt text such as "Enter a payment password" or "Please enter a payment password". The prompt information is used to prompt the user to enter the payment password. The input box is used to input the payment password by the user. Each input box corresponds to one bit of the payment password, and a quantity of input boxes is the same as a quantity of bits of the payment password. Specifically, FIG. 8 is a schematic diagram of a verification page for entering a payment password according to this specification. For example, the prompt information on the verification page shown in FIG. 8 is "Enter a payment password". For example, the payment password has five bits. In this case, the verification page shown in FIG. 8 includes five input boxes, and the user has entered two bits of the password. The client can determine, in response to an input operation of the user, a password entered by the user, and send the password to the server. Then, the server can determine, based on pre-stored user information, whether the password is a payment password of the user. If yes, it is determined that user verification succeeds, and a message indicating that user verification succeeds is sent to the client, so that the client sends, to the server, the message indicating that the user performs subscription. If no, it is determined that user verification fails, and a message indicating that user verification fails is sent to the client, so that the client can generate prompt information "Verification fails", and display the prompt information to the user. Subsequently, the user can re-enter the payment password, to re-verify the identity of the user. A specific process is similar to the above-mentioned content, and details are not described herein again. In addition, when a plurality of times of verification of the user still fail, that is, user verification still fails when a quantity of times of user verification reaches for a specified quantity of times, the server directly sends second information to the payment service provider, so that the payment service provider returns the second information to the merchant platform, to notify the merchant platform that user verification fails, so that the merchant platform generates the subscription failure page and displays the subscription failure page to the user.

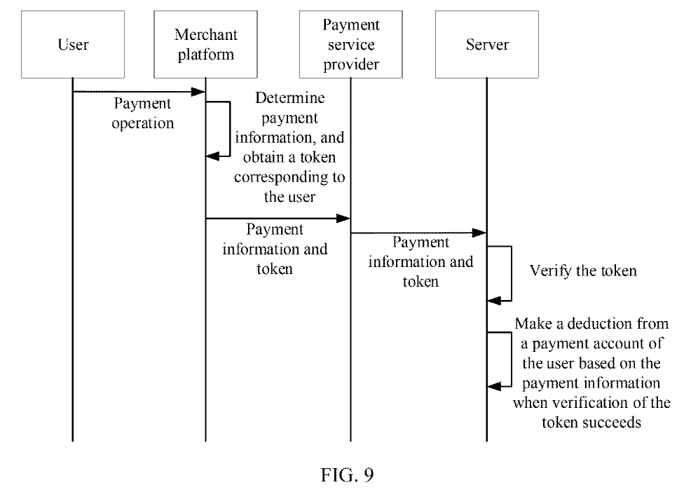

In one or more embodiments of this specification, after subscription is performed, the merchant platform can perform payment in a deduction manner. A specific process is shown in FIG. 9. FIG. 9 is a schematic diagram of a payment process according to this specification. The merchant platform can further determine payment information in response to a payment operation of the user, and obtain a token corresponding to the user. The payment information and the token are sent to the payment service provider. The payment service provider can further send the payment information and the token to the server. The server can further verify the received token. A deduction is made from a payment account of the user based on the payment information when verification of the token succeeds. The payment information includes at least a user identifier and a payment amount. The user identifier is used by the server to confirm the payment account of the user. The above-mentioned process of verifying the received token is similar to the above-mentioned process of verifying the authorization code, and details are not described herein again.

After the server makes a deduction from the payment account of the user, the server can transfer a deduction (namely, a payment amount) from the payment account of the user to the payment service provider, so that the payment service provider transfers the payment amount to the merchant platform. After the deduction is made, the server can directly transfer the payment amount to the payment service provider, or can transfer the payment amount to the payment service provider based on a period. This is not specifically limited in this specification. In addition, after receiving the payment amount, the payment service provider can directly transfer the payment amount to the merchant platform, or can transfer the payment amount to the merchant platform based on a period. This is not specifically limited in this specification.

In one or more embodiments of this specification, the merchant platform stores tokens corresponding to several users. When a user performs a payment, that is, responds to the payment operation of the user, the merchant platform can first determine whether the token corresponding to the user is stored. If yes, the merchant platform obtains the token corresponding to the user, determines the payment information, and then performs payment in a deduction payment manner based on the token and the payment information. If not, the merchant platform can generate subscription prompt information and display the subscription prompt information to the user, to prompt the user that subscription can be performed, so that subsequently the merchant platform can perform a payment in a deduction payment manner. A process in which the user performs subscription is described in the above-mentioned content of the system shown in FIG. 3, and details are not described herein again. After a user subscription success page is displayed, the merchant platform can obtain the token corresponding to the user, determine the payment information, and then performs a payment in a deduction payment manner based on the token and the payment information.

In one or more embodiments of this specification, after the server makes a deduction from the payment account of the user, the server can generate a payment success message and send the payment success message to the payment service provider. The payment service provider sends the payment success message to the merchant platform, so that the merchant platform can determine that the server has made a deduction from the payment account of the user. In this case, the merchant platform can generate the payment success page and display the payment success page to the user, so that the user determines that payment succeeds.

In one or more embodiments of this specification, when the client can return the subscription result, the client can return the subscription result to the payment service provider, and then the payment service provider returns the subscription result to the merchant platform. The client can directly return the subscription result to the merchant platform. Specifically, the client can generate a jump-back address, concatenate the subscription result with the jump-back address, and then return a concatenation result to the merchant platform, so that the merchant platform renders a merchant page based on the concatenation result, and displays the merchant page to the user. In addition, the merchant platform can determine the subscription result from the received concatenation result. The jump-back address is an address corresponding to the merchant platform, and the merchant page can be any preset page of the merchant platform. Certainly, the merchant page can be a blank page. This is not specifically limited in this specification.

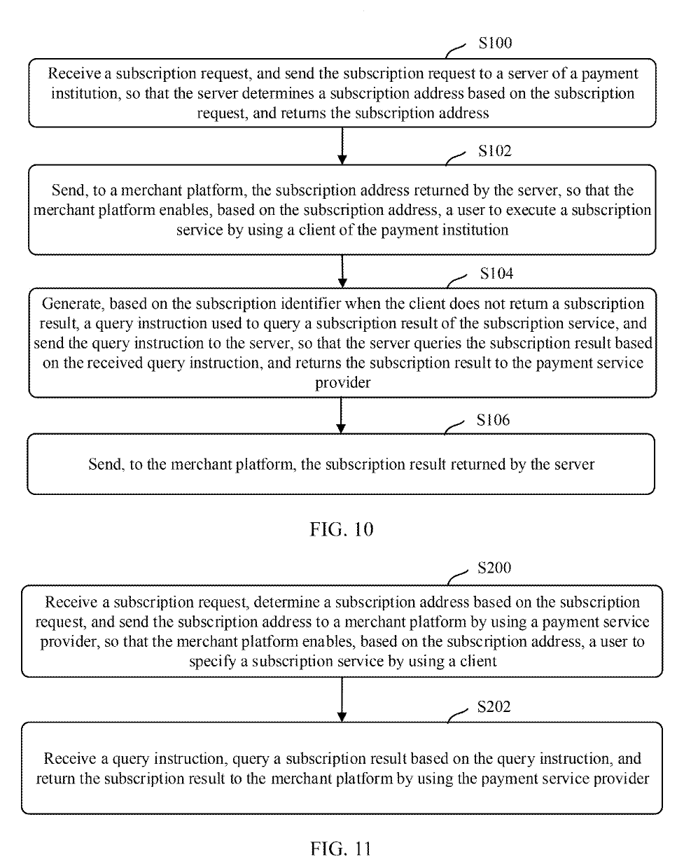

This specification further provides an online subscription method. The method is applied to a payment service provider, and the payment service provider is deployed in an online subscription system. The online subscription system includes a merchant platform, a payment institution, and a payment service provider. The payment institution includes a client and a server, as shown in FIG. 10. FIG. 10 is a schematic flowchart of an online subscription method according to this specification. Specifically, the following steps are specifically included:

S100: Receive a subscription request, and send the subscription request to a server of a payment institution, so that the server determines a subscription address based on the subscription request, and returns the subscription address, where the subscription request is sent by a merchant platform to the payment service provider, the subscription request includes at least a subscription identifier, and the subscription identifier is used to uniquely identify a subscription service corresponding to the subscription request.

The payment service provider can receive the subscription request, and send the subscription request to the server of the payment institution, so that the server determines the subscription address based on the subscription request, and returns the subscription address. The subscription request is sent by the merchant platform to the payment service provider, and the subscription request includes at least the subscription identifier. The subscription identifier is used to uniquely identify a subscription service corresponding to the subscription request. Each subscription request corresponds to one subscription service, and each subscription service has a unique subscription identifier. In addition, in addition to the subscription identifier, the subscription request can further include an institution identifier. The institution identifier is a unique identifier of the payment institution, and each payment institution has a corresponding unique institution identifier.

Specifically, the merchant platform sends the subscription request of the user to the payment service provider in response to the subscription request. The payment service provider can receive the subscription request sent by the merchant platform, and send the subscription request to the server of the payment institution, so that the server determines the subscription address based on the subscription request, and returns the subscription address. The subscription address can be generated by the server based on the subscription request, and the subscription address is an address corresponding to a subscription page. The subscription request can further include a platform identifier. The platform identifier is a unique identifier of the merchant platform. The subscription request can include the institution identifier, and the payment service provider can access a plurality of payment institutions. Therefore, when sending the subscription request to the server of the payment institution, the payment service provider can determine the payment institution corresponding to the institution identifier based on the institution identifier in the subscription request, and send the subscription request to the server of the payment institution corresponding to the institution identifier. The institution identifier can be an identifier of a payment institution selected by the user. A specific process is similar to the process described in the above-mentioned online subscription system shown in FIG. 3, and details are not described herein again. In addition, a process in which the server determines the subscription address based on the subscription request is also similar to a process in which the server can be configured to determine the subscription address based on the received subscription request in the above-mentioned online subscription system shown in FIG. 3. Details are not described herein again.

S102: Send, to the merchant platform, the subscription address returned by the server, so that the merchant platform enables, based on the subscription address, the user to execute the subscription service by using a client of the payment institution.

The payment service provider can send, to the merchant platform, the subscription address returned by the server, so that the merchant platform enables, based on the subscription address, the user to execute the subscription service by using the client of the payment institution. The subscription service is that the user performs a subscription operation or cancellation operation on a subscription page displayed on the client. A specific process in which the merchant platform enables, based on the subscription address, the user to execute the subscription service by using the client of the payment institution is similar to the process described in the above-mentioned online subscription system shown in FIG. 3. Details are not described herein again.

S104: Generate, based on the subscription identifier when the client does not return a subscription result, a query instruction used to query a subscription result of the subscription service, and send the query instruction to the server, so that the server queries the subscription result based on the received query instruction, and returns the subscription result to the payment service provider.

S106: Send, to the merchant platform, the subscription result returned by the server.

The payment service provider can generate, based on the subscription identifier when the client does not return the subscription result, the query instruction used to query the subscription result of the subscription service, and send the query instruction to the server, so that the server queries the subscription result based on the received query instruction, and returns the subscription result to the payment service provider. Then, the payment service provider sends, to the merchant platform, the subscription result returned by the server. The query instruction is used to query the subscription result of a subscription service, and the query instruction carries the subscription identifier. The subscription result includes one of the authorization code and the failure information. A specific process in which the server queries the subscription result based on the received query instruction, and returns the subscription result to the payment service provider is similar to the process described in the above-mentioned online subscription system shown in FIG. 3. Details are not described herein again.

It can be learned from the above-mentioned online subscription method that during online subscription, the payment service provider receives the subscription request, and then sends the subscription request to the server. The server can determine the subscription address based on the received subscription request, and send the subscription address to the merchant platform by using the payment service provider, so that the merchant platform can enable, based on the subscription address, the user to execute the subscription service by using the client. When the client does not return the subscription result, the payment service provider can generate, based on the subscription identifier, the query instruction used to query the subscription result of the subscription service, and send the query instruction to the server. The server queries the subscription result based on the received query instruction, and returns the subscription result. Then, the payment service provider returns the subscription result to the merchant platform. When the client does not return the subscription result, the payment service provider actively sends the query instruction to the server of the payment institution, so that the server queries the subscription result based on the query instruction, and returns the subscription result to the payment service provider. This avoids a problem that the client cannot return the subscription result to the payment service provider because the network quality of the region in which the user is located is poor, the user performs a misoperation, or the user terminal is faulty, to avoid a case in which the merchant platform waits for a long period of time, improve a subscription speed of the user, and improve a total transaction amount of the merchant.

In one or more embodiments of this specification, before sending the subscription address to the merchant platform, or after receiving the subscription address returned by the server, and when the client does not return the subscription result, the payment service provider can generate, based on the subscription identifier, the query instruction used to query the subscription result of the subscription service, and send the query instruction to the server, so that the server queries the subscription result based on the query instruction, and returns the subscription result. However, if the client returns the subscription result in this case, the payment service provider can directly return, to the merchant platform, the subscription result returned by the client. In addition, after the query instruction is generated, the payment service provider can send the query instruction to the server based on a specified period. In addition, a maximum quantity of queries can be limited. A specific process is similar to the process described in the above-mentioned online subscription system shown in FIG. 3. Details are not described herein again.

In one or more embodiments of this specification, to reduce a waste of resources of the payment service provider, when the client does not return the subscription result in step S104, the payment service provider can determine a delay time corresponding to the payment institution when generating, based on the subscription identifier, the query instruction used to query the subscription result of the subscription service. The query instruction used to query the subscription result of the subscription service is generated based on the subscription identifier when the client does not return the subscription result within the delay time. The delay time can be preset by the payment service provider, and the delay time is usually greater than a time required for executing the subscription service by the user. In addition, when the client returns the subscription result within the delay time, the payment service provider directly returns, to the merchant platform, the subscription result returned by the client. In addition, after the query instruction is generated, the payment service provider can send the query instruction to the server based on a specified period. In addition, a maximum quantity of queries can be limited. A specific process is similar to the process described in the above-mentioned online subscription system shown in FIG. 3. Details are not described herein again.

In one or more embodiments of this specification, the payment service provider can further determine the delay time corresponding to the payment institution before sending, to the merchant platform, the subscription address returned by the server, or after receiving the subscription address returned by the server. A delay message is generated based on the delay time, and sent to the payment service provider. Based on this, the query instruction used to query the subscription result of the subscription service is generated based on the subscription identifier when the client does not return the subscription result in step S104, the payment service provider can generate, based on the subscription identifier when the client does not return the subscription result before the delay message is received, the query instruction used to query the subscription result of the subscription service. The delay message can include the subscription identifier. The delay message is used to delay generating and sending the query instruction by the payment service provider. Usually, after the delay message is sent to the payment service provider, the delay message is received only after the delay time elapses. That is, a time from sending of the delay message to receiving of the delay message is a delay time. In addition, after the query instruction is generated, the payment service provider can send the query instruction to the server based on a specified period. In addition, a maximum quantity of queries can be limited. A specific process is similar to the process described in the above-mentioned online subscription system shown in FIG. 3. Details are not described herein again.

In one or more embodiments of this specification, when the payment service provider stops sending the query instruction to the server, to avoid a case in which the merchant platform waits for a long period of time, the payment service provider can generate a first message, and return the first message to the merchant platform, to notify the merchant platform that the payment service provider does not obtain the subscription result. The merchant platform can generate the subscription failure page based on the first message returned by the payment service provider, and display the subscription failure page to the user. The first message represents that the payment service provider does not obtain the subscription result.

In one or more embodiments of this specification, the payment service provider can further receive, based on a preset interface, the authorization code sent by the merchant platform. The authorization code is generated by the server when the user subscribes successfully. The authorization code is sent to the server, so that the server determines a token based on the authorization code, and returns the token to the payment service provider. The token returned by the server is sent to the merchant platform, so that the merchant platform displays a subscription success page to the user. A specific process is similar to the above-mentioned process shown in FIG. 7. Details are not described herein again.

In one or more embodiments of this specification, the payment service provider can further receive payment information and a token that are sent by the merchant platform. The token and the payment information are sent to the server, so that the server verifies the token, and makes a deduction from a payment account of the user based on the payment information when verification of the token succeeds. A specific process is similar to the above-mentioned process shown in FIG. 9. Details are not described herein again.

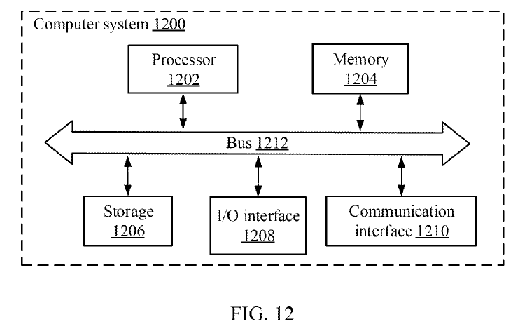

This specification further provides an online subscription method. The method is applied to a server, and the server is deployed in an online subscription system. The online subscription system includes a merchant platform, a payment institution, and a payment service provider. The payment institution includes a client and a server, as shown in FIG. 11. FIG. 11 is a schematic flowchart of another online subscription method according to this specification. Specifically, the following steps are specifically included:

S200: Receive a subscription request, determine a subscription address based on the subscription request, and send the subscription address to a merchant platform by using a payment service provider, so that the merchant platform enables, based on the subscription address, a user to specify a subscription service by using a client, where the subscription request is sent by the merchant platform to a server by using the payment service provider, the subscription request includes at least a subscription identifier, and the subscription identifier is used to uniquely identify a subscription service corresponding to the subscription request.

S202: Receive a query instruction, query a subscription result based on the query instruction, and return the subscription result to the merchant platform by using the payment service provider, where the query instruction is generated by the payment service provider based on the subscription identifier when the client does not return the subscription result, and the query instruction is used to query a subscription result of the subscription service.

The server can receive the subscription request, determine the subscription address based on the subscription request, and send the subscription address to the merchant platform by using the payment service provider. The merchant platform enables, based on the subscription address, the user to specify the subscription service by using the client. Then, the query instruction is received, the subscription result is queried based on the query instruction, and the subscription result is returned to the merchant platform by using the payment service provider. The subscription request is sent by the merchant platform to the server by using the payment service provider, the subscription request includes at least the subscription identifier, and the subscription identifier is used to uniquely identify the subscription service corresponding to the subscription request. The query instruction is generated by the payment service provider based on the subscription identifier when the client does not return the subscription result, and the query instruction is used to query the subscription result of the subscription service. A specific process is similar to the process described in the system shown in FIG. 3. Details are not described herein again.

The specification also provides a computer-readable non-transitory storage medium, where the storage medium stores a computer program, which, when executed by a processor, can be used to perform one or more steps of one or more methods described or illustrated herein or provides functionality described or illustrated herein. Herein, the computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The specification also provides a computer system. FIG. 12 illustrates an example computer system 1200. In particular embodiments, one or more computer systems 1200 perform one or more steps of one or more methods described or illustrated herein. In particular embodiments, one or more computer systems 1200 provide functionality described or illustrated herein. In particular embodiments, software running on one or more computer systems 1200 performs one or more steps of one or more methods described or illustrated herein or provides functionality described or illustrated herein. Particular embodiments include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In particular embodiments, memory 1204 includes main memory for storing instructions for processor 1202 to execute or data for processor 1202 to operate on. As an example and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In particular embodiments, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory, this disclosure contemplates any suitable memory.

In particular embodiments, storage 1206 includes mass storage for data or instructions. As an example and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In particular embodiments, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In particular embodiments, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In particular embodiments, communication interface 1210 includes hardware, software, or both providing one or more interfaces for communication (such as, for example, packet-based communication) between computer system 1200 and one or more other computer systems 1200 or one or more networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

The above-mentioned descriptions are merely embodiments of this specification, and are not intended to limit this specification. A person skilled in the art can make various changes and changes to this specification. Any modification, equivalent replacement, improvement, etc. made without departing from the spirit and principle of this specification shall fall within the scope of the claims in this specification.

What is claimed is:

1. An system for online subscription, wherein the system comprises a merchant platform, a payment institution, and a payment service provider, and the payment institution comprises a client and a server; wherein:
the merchant platform is configured to send a subscription request of a user to the server by using the payment service provider in response to the subscription request, wherein the subscription request comprises at least a subscription identifier, and the subscription identifier is used to uniquely identify a subscription service corresponding to the subscription request;
the server is configured to: determine a subscription address based on the subscription request, and send the subscription address to the merchant platform by using the payment service provider;
the merchant platform is configured to enable, based on the subscription address, the user to execute the subscription service by using the client;
the payment service provider is configured to: generate, based on the subscription identifier in response to that the client does not return a subscription result, a query instruction used to query the subscription result of the subscription service, and send the query instruction to the server; and
the server is configured to: query the subscription result based on the query instruction, and return the subscription result to the merchant platform by using the payment service provider.

2. The system according to claim 1, wherein the payment service provider is configured to:
determine a delay time corresponding to the payment institution; and
generate, based on the subscription identifier in response to that the client does not return the subscription result within the delay time, the query instruction used to query the subscription result of the subscription service.

3. The system according to claim 1, wherein:
the payment service provider is further configured to:
before sending the subscription address to the merchant platform, determine a delay time corresponding to the payment institution; and
generate a delay message based on the delay time, and send the delay message to the payment service provider; and
the payment service provider is configured to: generate, based on the subscription identifier in response to that the client does not return the subscription result before the delay message is received, the query instruction used to query the subscription result of the subscription service.

4. The system according to claim 1, wherein the subscription result comprises one of an authorization code or failure information; and
the merchant platform is further configured to:
in response to that the subscription result is the authorization code, determine a token based on the authorization code by interacting with the payment service provider, and display a subscription success page to the user; and
in response to that the subscription result is the failure information, generate a subscription failure page, and display the subscription failure page to the user.

5. The system according to claim 4, wherein the merchant platform is configured to invoke a preset interface to send the authorization code to the payment service provider;
the payment service provider is further configured to send, to the server, the authorization code received based on the preset interface;
the server is further configured to: determine the token based on the authorization code, and return the token to the payment service provider;
the payment service provider is further configured to send the token to the merchant platform; and
the merchant platform is configured to receive the token returned by the payment service provider.

6. The system according to claim 1, wherein the merchant platform is further configured to: in response to that a subscription result returned by the payment service provider is not received within a specified time, determine that the subscription service fails, generate a subscription failure page, and display the subscription failure page to the user.

7. The system according to claim 4, wherein the merchant platform is further configured to: in response to a payment operation of the user, determine payment information, and obtain the token corresponding to the user; and send the payment information and the token to the payment service provider;
the payment service provider is further configured to send the payment information and the token to the server; and
the server is further configured to: verify the token; and make a deduction from a payment account of the user based on the payment information in response to that verification of the token succeeds.

8. A computer-implemented method, wherein the computer-implemented method is applied to, and the computer-implemented method comprises:
receiving, from a merchant platform by a payment service provider, a subscription request;
sending the subscription request to a server of a payment institution, wherein the subscription request comprises at least a subscription identifier, and the subscription identifier is used to uniquely identify a subscription service corresponding to the subscription request;
receiving, from the server, a subscription address determined based on the subscription request,
sending, to the merchant platform, the subscription address, wherein a user is enabled to execute the subscription service by using a client of the payment institution based on the subscription address,;
generating, based on the subscription identifier in response to that the client does not return a subscription result, a query instruction used to query the subscription result of the subscription service;
sending the query instruction to the server;
receiving, from the server, the subscription result based on the query instruction; and
sending, to the merchant platform, the subscription result.

9. The computer-implemented method according to claim 8, wherein the generating, based on the subscription identifier in response to that the client does not return a subscription result, a query instruction used to query the subscription result of the subscription service comprises:
determining a delay time corresponding to the payment institution; and
generating, based on the subscription identifier in response to that the client does not return the subscription result within the delay time, the query instruction used to query the subscription result of the subscription service.

10. The computer-implemented method according to claim 8, wherein before the sending, to the merchant platform, the subscription address returned by the server, the computer-implemented method further comprises:
determining a delay time corresponding to the payment institution; and
generating a delay message based on the delay time;
sending the delay message to the payment service provider; and
the generating, based on the subscription identifier in response to that the client does not return a subscription result, a query instruction used to query the subscription result of the subscription service comprises:
generating, based on the subscription identifier in response to that the client does not return the subscription result before the delay message is received, the query instruction used to query the subscription result of the subscription service.

11. The computer-implemented method according to claim 8, wherein the subscription result comprises an authorization code; and the computer-implemented method further comprises:
receiving, based on a preset interface, the authorization code from the merchant platform, wherein the authorization code is generated in response to that the user subscribes successfully;
sending the authorization code to the server;
receiving a token determined based on the authorization code; and
sending, to the merchant platform, the token, wherein a subscription success page is displayed to the user.

12. The computer-implemented method according to claim 11, wherein the computer-implemented method further comprises:
receiving payment information and the token from the merchant platform; and
sending the token and the payment information to the server.

13. The computer-implemented method according to claim 8, wherein the subscription result comprises failure information; and the computer-implemented method further comprises:
in response to that the subscription result is the failure information, generating, by the merchant platform, a subscription failure page, and displaying the subscription failure page to the user.

14. The computer-implemented method according to claim 8, wherein the subscription result comprises an authorization code, and the computer-implemented method further comprises:
invoking, by the merchant platform, a preset interface to send the authorization code to the payment service provider;
sending, by the payment service provider to the server, the authorization code received based on the preset interface.

15. The computer-implemented method according to claim 8, wherein the computer-implemented method further comprises:
in response to that a subscription result returned by the payment service provider is not received within a specified time, determining, by the merchant platform, that the subscription service fails, generating a subscription failure page, and displaying the subscription failure page to the user.

16. A computer-implemented system of a payment service provider, comprising:
one or more computers; and
one or more computer memory devices interoperably coupled with the one or more computers and having tangible, non-transitory, machine-readable media storing one or more instructions that, when executed by the one or more computers, perform operations comprising:
receiving, from a merchant platform, a subscription request;
sending the subscription request to a server of a payment institution, wherein the subscription request comprises at least a subscription identifier, and the subscription identifier is used to uniquely identify a subscription service corresponding to the subscription request;
receiving, from the server, a subscription address determined based on the subscription request,
sending, to the merchant platform, the subscription address, wherein a user is enabled to execute the subscription service by using a client of the payment institution based on the subscription address,;
generating, based on the subscription identifier in response to that the client does not return a subscription result, a query instruction used to query the subscription result of the subscription service;
sending the query instruction to the server;
receiving, from the server, the subscription result based on the query instruction; and
sending, to the merchant platform, the subscription result.

17. The computer-implemented system according to claim 16, wherein the generating, based on the subscription identifier in response to that the client does not return a subscription result, a query instruction used to query the subscription result of the subscription service comprises:
determining a delay time corresponding to the payment institution; and
generating, based on the subscription identifier in response to that the client does not return the subscription result within the delay time, the query instruction used to query the subscription result of the subscription service.

18. The computer-implemented system according to claim 16, wherein before the sending, to the merchant platform, the subscription address returned by the server, the operations further comprise:
determining a delay time corresponding to the payment institution; and
generating a delay message based on the delay time;
sending the delay message to the payment service provider; and
the generating, based on the subscription identifier in response to that the client does not return a subscription result, a query instruction used to query the subscription result of the subscription service comprises:
generating, based on the subscription identifier in response to that the client does not return the subscription result before the delay message is received, the query instruction used to query the subscription result of the subscription service.

19. The computer-implemented system according to claim 16, wherein the subscription result comprises an authorization code; and the operations further comprise:
receiving, based on a preset interface, the authorization code from the merchant platform, wherein the authorization code is generated in response to that the user subscribes successfully;
sending the authorization code to the server;
receiving a token determined based on the authorization code; and
sending, to the merchant platform, the token, wherein a subscription success page is displayed to the user.

20. The computer-implemented system according to claim 19, wherein the operations further comprise:
receiving payment information and the token from the merchant platform; and
sending the token and the payment information to the server.
